(19) United States
(12) Patent Application Publication
(10) Pub. No.: US 2017/0316925 A1
(43) Pub. Date: Nov. 2, 2017

(54) A Two-Dimensional Anode Array Or Two-Dimensional Multi-Channel Anode For Large-Area Photodetection

(71) Applicant: InnoSys, Inc., Salt lake City, UT (US)

(72) Inventors: Ruey-Jen Hwu, Salt Lake City, UT (US); Laurence P. Sadwick, Salt Lake City, UT (US); Jishi Ren, Ottawa Ontario (CA); Derrick K. Kress, Salt Lake City, UT (US)

(21) Appl. No.: 15/528,090

(22) PCT Filed: Nov. 18, 2015
(86) PCT No.: PCT/US15/61440

§ 371 Date: May 18, 2017

Related U.S. Application Data
(60) Provisional application No. 62/081,156, filed on Nov. 18, 2014.
(60) Provisional application No. 62/099,577, filed on Jan. 4, 2015.
(60) Provisional application No. 62/246,545, filed on Oct. 26, 2015.

(51) Int. Cl. H01J 43/12

(52) U.S. Cl. CPC H01J 43/12

(57) ABSTRACT

A two-dimensional anode array or two-dimensional multi-channel anode includes a substrate, a number of conductive regions on the substrate, and a number of electrical conductors through the substrate, each connected to one of the conductive regions for receiving and readout of the signal from the photodetector or photomultiplier.

### BACKGROUND

Large area detection using multi-channel photodetectors or photomultipliers are used in a range of applications such as, but not limited to, particle collider detectors, x-ray detectors, astronomical applications, medical applications, etc. When photons strike a photocathode in the photodetector, electrons are emitted from the photocathode and are received in an adjacent anode, generating an electrical current in the anode as an indicator of the photon. In many applications, both timing resolution and spatial resolution in the anode are critical. However, design, manufacture of the design, and configuration of the detection scheme that increase timing resolution and spatial resolution can be difficult. This is because large area detection naturally has lower time resolution and to increase spatial resolution of large area detection, two dimensional detection is necessary yet very difficult to configure.

### SUMMARY

Various apparatuses and methods for an anode design for large area photodetection which is capable of high bandwidth or increased time resolution and high density or high population detection are disclosed herein. In some embodiments, the anode includes a two-dimensional array of conductive pads on a substrate, with connections for each of the conductive pads being located on an opposite side of the substrate, such that the conductive pads can be under vacuum while the connections are easily accessible outside the vacuum.

This summary provides only a general outline of some exemplary embodiments. Many other objects, features, advantages and other embodiments will become more fully apparent from the following detailed description, the appended claims and the accompanying drawings.

### BRIEF DESCRIPTION OF THE DRAWINGS

A further understanding of the various exemplary embodiments may be realized by reference to the figures which are described in remaining portions of the specification. In the figures, like reference numerals may be used throughout several drawings to refer to similar components.

FIG. 1 depicts a perspective view of an anode assembly with pads on an upper, vacuum side of a substrate and with coaxial connections on a non-vacuum underside of the substrate connected to the pads by feedthrough conductors through the substrate in accordance with some embodiments of the invention.

FIG. 2 depicts a top view of the upper, vacuum side of the anode assembly of FIG. 1 in accordance with some embodiments of the invention.

FIG. 3 depicts a bottom view of the non-vacuum underside of the anode assembly of FIG. 1 in accordance with some embodiments of the invention.

FIG. 4 depicts a side cross-section view of an anode pad positioned on a top side of a substrate with a passage or hole provided for a contact feedthrough from the anode pad to a bottom side of the substrate in accordance with some embodiments of the invention.

FIG. 5 depicts a side cross-section view of the anode pad of FIG. 8 bonded to the top side of the substrate with an anodic bonding in accordance with some embodiments of the invention.

FIG. 6 depicts a side cross-section view of the anode pad of FIG. 4 with electroplating or other conductive material in the passage in accordance with some embodiments of the invention.

FIG. 7 depicts a side cross-section view of the anode pad of FIG. 4 with anodic bonding and feedthrough plating in accordance with some embodiments of the invention.

FIG. 8 depicts a cross-sectional perspective view of the anode pad and substrate of FIG. 4 with a feedthrough passage providing access to the anode pad opposite the vacuum side in accordance with some embodiments of the invention.

FIG. 9 depicts a cross-sectional perspective view of the anode pad of FIG. 4 with electroplating or other conductive material in the feedthrough passage in accordance with some embodiments of the invention.

FIG. 10 depicts a perspective view of the anode pad of FIG. 4, multiple copies of which can be provided in an array to form a multi-channel two dimensional anode structure in accordance with some embodiments of the invention.

FIG. 11 depicts a side cross-section view of an elongated anode pad positioned on a top side of a substrate with contact feedthroughs through the substrate at each end of the elongated anode pad, allowing for arrays of elongated anode pad within a vacuum to be electrically connected to connectors outside the vacuum.

FIG. 12 depicts a perspective view of the elongated anode pad and substrate of FIG. 15 in accordance with some embodiments of the invention.

FIG. 13 depicts an anode assembly with two-dimensional pads and a signal combining circuit in accordance with some embodiments of the invention.

FIG. 14 depicts a perspective view of an anode with an array of conductive pads surrounded by a ground plane in accordance with some embodiments of the invention.

FIG. 15 depicts a top view of the anode of FIG. 14 in accordance with some embodiments of the invention.

FIG. 16 depicts a bottom view of the anode of FIG. 14 in accordance with some embodiments of the invention.

FIG. 17 depicts a side view of the anode of FIG. 14 in accordance with some embodiments of the invention.

FIG. 18 depicts a perspective view of an anode with an array of conductive pads surrounded by a ground plane and showing multiple layers of the anode in accordance with some embodiments of the invention.

FIG. 19 depicts a side view of the anode of FIG. 18 in accordance with some embodiments of the invention.

FIG. 20 depicts a top view of the upper, vacuum side of an anode with a two-dimensional array of elongated pads, showing the pads that in some embodiments are positioned inside a vacuum in accordance with some embodiments of the invention.

FIG. 21 depicts a bottom view of the non-vacuum underside of the anode of FIG. 20, showing the elongated pads of the vacuum side with dashed lines, showing the connectors at the ends of each of the elongated pads, providing connections outside the vacuum to the elongated pads inside the vacuum, and showing a ground plane on the bottom side outside the vacuum.

FIG. 22 depicts a top view of the upper, vacuum side of an embodiment of a multi-channel anode, in which a two-dimensional array of elongated pads are located on the vacuum side in accordance with some embodiments of the invention.

FIG. 23 depicts a bottom view of the non-vacuum underside of the multi-channel anode of FIG. 22, showing a two-dimensional array of elongated pads on the non-vacuum side, inductively coupled to the two-dimensional array of elongated pads on the vacuum side shown in FIG. 22, allowing the signal to be retrieved outside the vacuum.

FIG. 24 depicts a bottom view of the non-vacuum underside of a multi-channel anode in which a two-dimensional array of elongated pads is positioned on the non-vacuum side of a glass substrate, surrounded by a ground plane in accordance with some embodiments of the invention.

### DESCRIPTION

The drawings and description, in general, disclose various embodiments of a two-dimensional multi-channel anode array that can be used in a multi-channel photodetection for large area and with high time resolution and high spatial resolution. In some embodiments, a multi-channel anode includes a substrate, a number of conductive regions or pads on the substrate, and a number of electrical conductors through the substrate, each connected to one of the conductive pads. In some embodiments, the substrate and the electrical conductors through the substrate are operable to maintain a pressure differential between a first side of the substrate and a second side of the substrate. This enables anode pads to be located within a photodetector housing under vacuum or partial vacuum, while the electrical conductors are accessible outside the vacuum.

The multi-channel anode can be used in any suitable application, such as, but not limited to, a multi-channel photodetector or a large area photodetector. The multi-channel anode is truly capable of areal detection with 2-dimensional anode array, having the signal pads or inputs inside the vacuum housing and connectors to the signal pads outside the vacuum. The pads are electrically conductive regions or patches that can be formed in any suitable shape and size, such as, but not limited to, rectangular, square, circular, or regions of any other shapes.

The multi-channel anode is configured for areal detection of any size including those large area ones. The size and distribution of the pads can be adapted to provide the desired cut-off frequency and bandwidth, as well as event density or population of the photodetection. For example, a large number of pads can be used to provide large-area photo-detection yet with a high cut-off frequency, such as, but not limited to, a cut-off frequency of about 5 GHz, although this frequency is merely an example. Various coupling methods, configurations and dimensions can be used to reduce coupling and cross-talk losses, thereby increasing cut-off frequencies. Such techniques to reduce coupling and cross talk losses include providing a reduced dielectric constant, which can be achieved by employing lower dielectric constant materials (as close to air as possible) or removing materials (replacing materials with air), etc. Unlike the current state of the art, the multi-channel anode disclosed herein is capable of two-dimensional high density/population detection of large areas. This is accomplished by employing distributed anode pads to fill a desired area. Generally, the anode pads are small enough that they do not behave like striplines, which minimizes coupling and cross-talk. The bandwidth and crosstalk are independent of the number of anode pads and are therefore independent of the overall system size.

Again, anode pads are provided on the inner, vacuum side of a substrate, and electrical connections to the anode pads are provided in some embodiments by electrically conductive feedthroughs through the substrate to the anode pads which provide electrical connections while maintaining a vacuum seal. Coaxial connections can thus be made to the feedthroughs on an outer side of the substrate, outside the vacuum. Output connectors are thus at the back of the vacuum sealed package in some embodiments, instead of the sides of the substrate, providing an effective means to collect signals from the multi-channel photomultiplier. For example, an 8″×8″ (200 mm×200 mm) plate with detection area of about 23.75 cm×23.75 cm filled with distributed pads as a 8×8=64 channel array offers a cut-off frequency of about 4.1 GHz and over 60% detection density. For another example, a larger array of, for example, 64×64 (1024 channels) array can be realized with 5 mm×5 mm pad while still offering cut-off frequency of about 5.6 GHz and over 60% detection density.

In some embodiments, the multi-channel anode is fabricated by drilling holes through an insulating substrate. A conductive layer is formed in a desired pattern to form individual signal inputs and, optionally, a ground plane on the non-vacuum side around feedthroughs or a ground plane on the vacuum side surrounding the pads. The holes through the insulating substrate are filled with a conductive material, connecting the signal inputs on one side of the substrate with the other side of the substrate. The holes are filled in a manner that will maintain a suitable pressure differential, allowing the signal inputs to be placed under vacuum on one side of the substrate, while connection pads or pins on the other side of the substrate remain outside the vacuum for convenient access. This provides electrical connections to the signal inputs without having to provide for electrical cables through the housing. The multi-channel anode provides for simple and low cost fabrication.

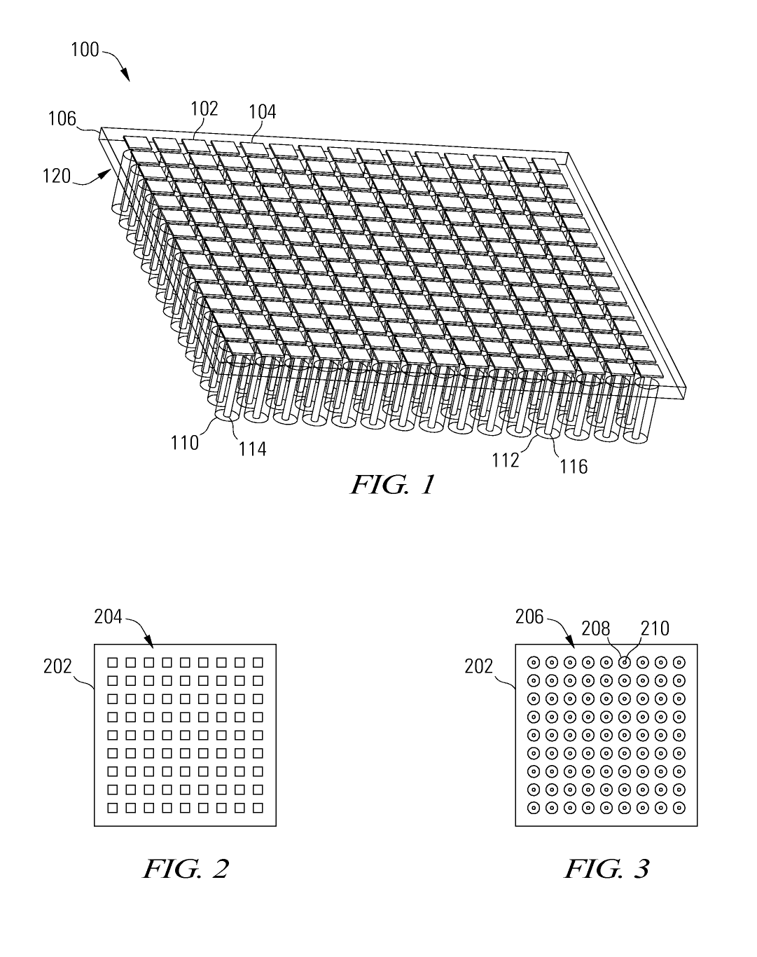

Turning to FIG. 1, a perspective view of a two-dimensional anode array or two-dimensional multi-channel anode 100 for large-area photodetection is depicted, with an array of anode pads (e.g., 102, 104) on an insulating substrate 106. The substrate 106 is depicted as transparent to show details. Feedthroughs with conductive fill material are provided through the substrate 106 for each of the pads (e.g., 102, 104), providing electrical connections through the substrate 106 while still maintaining an airtight seal between the upper and lower sides of the substrate 106 so that the pads (e.g., 102, 104) can be oriented to the inside of a photodetector housing and can be placed under vacuum. Pins or any suitable connectors can be provided to support connections to each of the feedthroughs, for example to support coaxial cables (e.g., 110, 112) being connected to each of the pads (e.g., 102, 104) using the feedthroughs. Coaxial cables (e.g., 110, 112) are depicted with the outer ground sheath and insulating cylinder being substantially transparent in FIG. 1 to show the inner signal conductor (e.g., 114, 116) of each coaxial cable (e.g., 110, 112). A ground plane 120 can be provided on the non-vacuum lower side of the substrate 106 so that the outer ground sheath of each coaxial cable (e.g., 110, 112) can be connected to the ground plane 120 while the inner signal conductor (e.g., 114, 116) of each coaxial cable (e.g., 110, 112) is connected one of the pads (e.g., 102, 104) using the feedthroughs, without their shorting to the ground plane 120.

Top and bottom views of the anode assembly 100 are depicted in FIGS. 2 and 3, respectively. An array of anode pads 104 are provided on the vacuum side of a substrate 102 and a ground plane 106 can be provided on the non-vacuum side of the substrate 102 in some embodiments, with cutouts or masked regions (e.g., 108) in the ground plane around anode feedthrough pins (e.g., 110). Thus, the multi-channel anode is not limited to any particular number, size, shape or layout of anode pads.

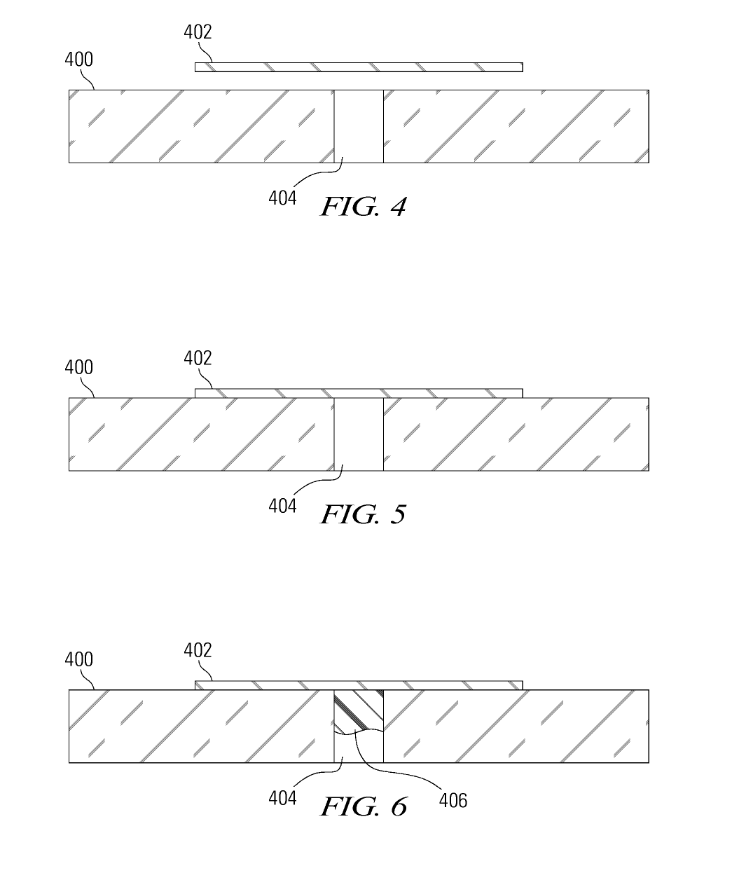

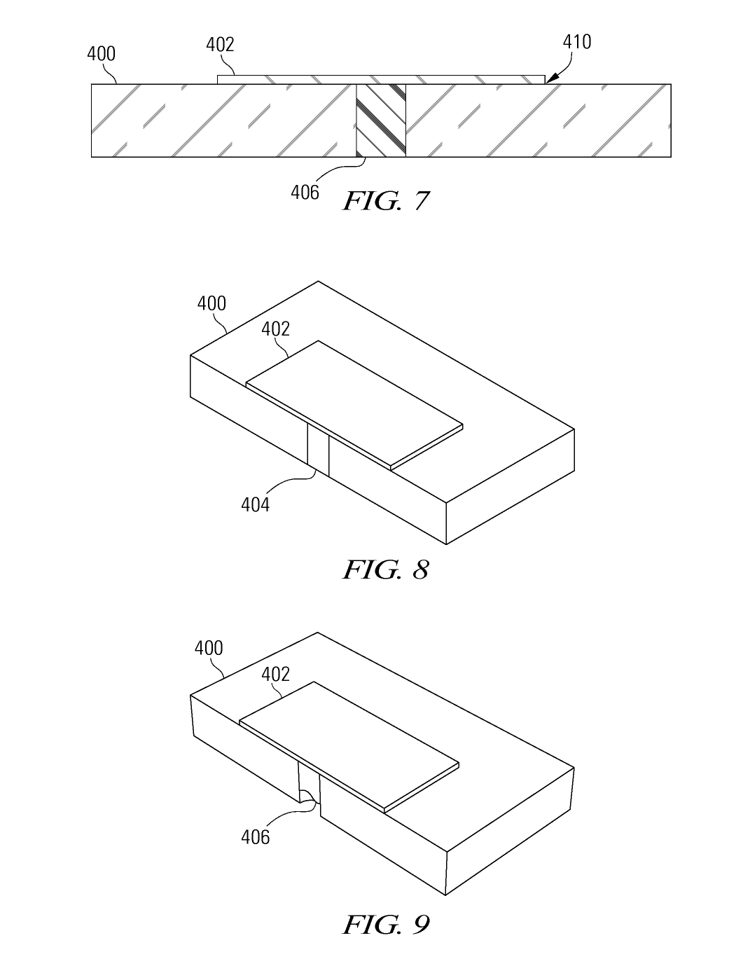

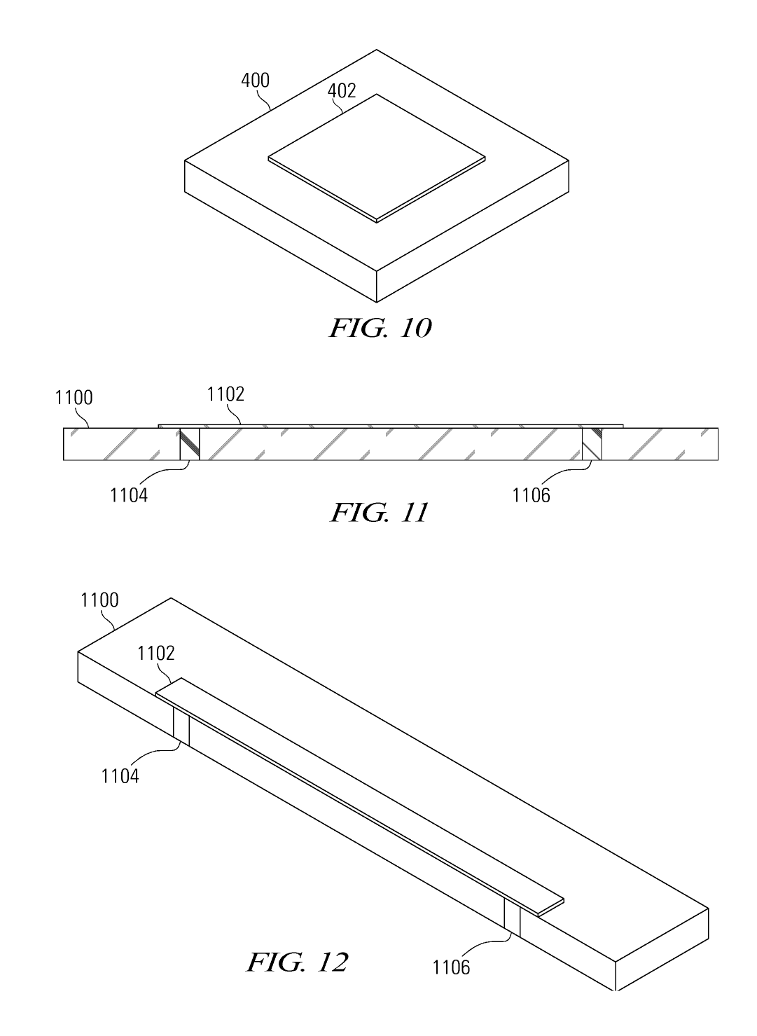

A single cell including an anode pad 402 with a conductive feedthrough connection through the substrate 400 is depicted in FIGS. 4-10. Multiple instances of such a cell can be formed in an array to provide a multi-channel anode. In FIG. 4, the anode pad 402 is depicted over the substrate 400, with a passage 404 drilled or otherwise formed through the substrate 400 providing access to the pad 402 through the substrate 400. Although the pad 402 is depicted above the substrate 400, the pad 402 can be fabricated and then mounted to the substrate 400 or can be fabricated/deposited directly onto the substrate 400 in any suitable manner. The pad is depicted in contact with the substrate 400 in FIG. 5, as it is positioned in the final anode assembly. As shown in FIG. 6, the feedthrough hole or passage 404 can be electroplated or filled in any suitable manner with a conductive material 406 that is capable of forming a vacuum seal between the upper and lower sides of the substrate 400. As shown in FIG. 7, the feedthrough hole or passage 404 is completely filled with the conductive material 406 in some embodiments to form the vacuum seal between the upper and lower sides of the substrate 400, and to provide an electrical connection between the pad 402 on the upper side of the substrate 400 and a coaxial cable or other connector (not shown) on the lower side of the substrate 400. Perspective cross-sectional views of the anode pad cell are depicted in FIGS. 8 and 9, and a perspective view of the cell including the anode pad 402 is depicted in FIG. 10.

In some other embodiments, anode pads can be provided with multiple feedthrough connections, such as the elongated pad 1102 depicted in the side view of FIG. 11 and the perspective cross-sectional view of FIG. 12. The pad 1102 is formed on the upper vacuum side of a substrate 1100, with vacuum sealing, electrically conductive feedthroughs 1104, 1106 being provided at distal ends of the pad 1102.

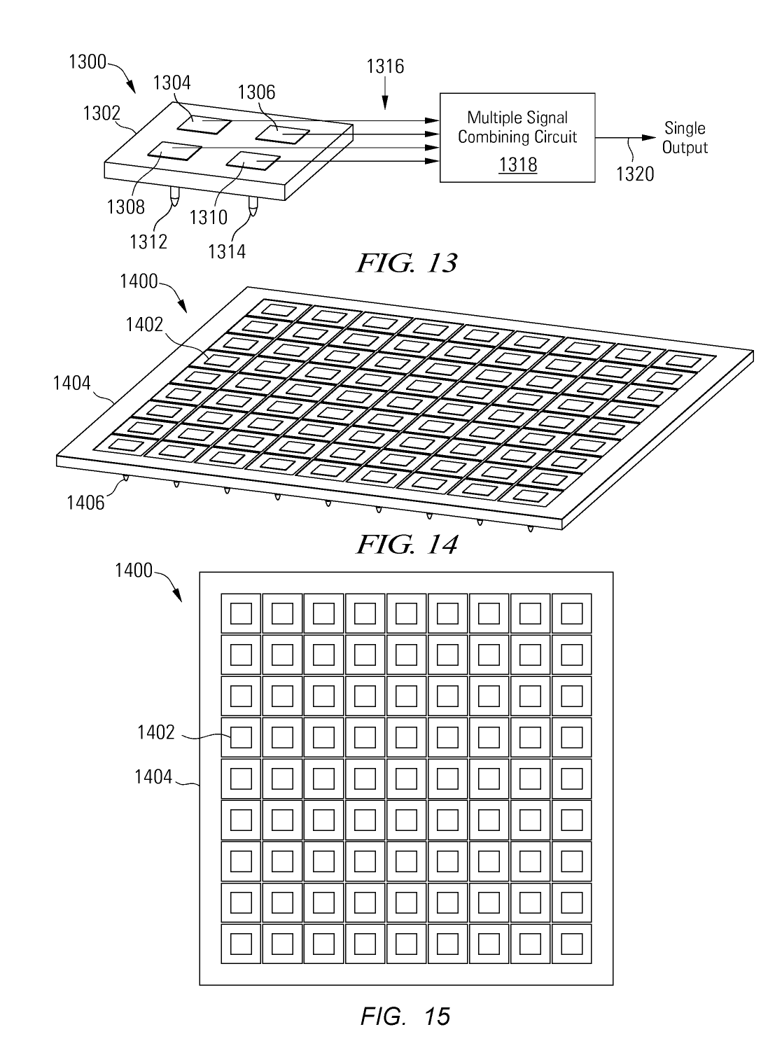

Turning to FIG. 13, a multi-channel anode assembly 1300 is depicted in perspective view that can be used in a large area photodetector in accordance with some embodiments of the invention.

The multi-channel anode assembly includes an array of anode pads 1304, 1306, 1308, 1310 mounted or fabricated on the vacuum side 1330 of an insulating substrate 1302 such as a glass substrate. Electrical pins or conductors 1312, 1314, 1334, 1336 pass through feedthrough holes in the substrate 1302 to a non-vacuum side, enabling connectors such as coaxial connectors to be connected to the anode pads 1304, 1306, 1308, 1310 using pins 1312, 1314, 1334, 1336. In some embodiments, a ground plane 1332 is provided on the non-vacuum side, with cutouts or insulating regions 1340, 1342, 1344, 1346 preventing the ground plane 1332 from contacting the pins 1312, 1314, 1334, 1336. The signal conductors of coaxial cables (not shown) can thus be connected to the pins 1312, 1314, 1334, 1336, with the insulating sheath of the coaxial cables connected to the ground plane 1332. The term vacuum side is also referred to herein as an upper side, and the term non-vacuum side is also referred to herein as a lower side. The vacuum side of the anode is oriented to the inside of a photodetector housing which can be pumped out to create a vacuum or partial vacuum. The non-vacuum side of the anode is oriented to the outside of the photodetector housing, providing convenient access to the electrical pins 1312, 1314, 1334, 1336.

The signals from the pins 1312, 1314, 1334, 1336 can be read or processed in any suitable manner, including by combining multiple signals 1316 in a signal combining circuit 1318 to yield a single output 1320. Such a signal combining circuit 1318 can be used in the case in which the number of small anode pads is higher than the desired readouts of a particular instrument in order to achieve the desired bandwidth or time-resolution. In this case, several small anode pads are multiplexed to read out any event occurring in the particular area that the small square regions are multiplexed together, e.g., to multiplex pads 1304, 1306, 1308, 1310 so that single output 1320 is asserted whenever a photon is received anywhere within the region covered by pads 1304, 1306, 1308, 1310.

Again, the number of pads on an anode assembly, as well as their size, shape, and layout, can be varied and adapted as desired to provide the needed detection area, cutoff frequency, bandwidth, location precision, etc.

It is important to note that this sealing and feedthrough method works for not just the pad anode design, but also for elongated anode pad designs. The feedthrough method can be used in a variety of designs not limited to the square pad anode design.

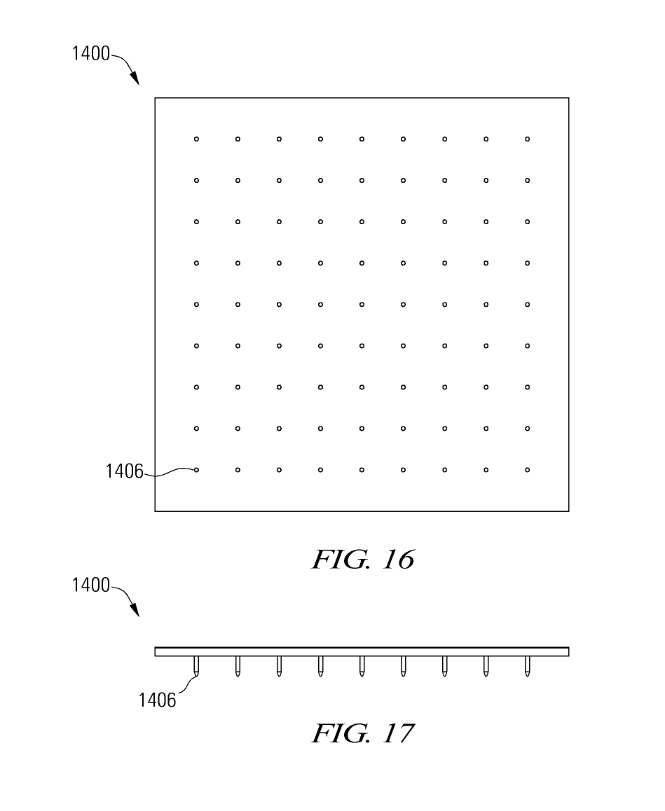

Turning to FIG. 14, a perspective view depicts a 9×9 two-dimensional anode array or two-dimensional multi-channel anode 1400 for large-area photodetection with a vacuum-side ground plane 1404 in accordance with some embodiments of the invention. Each anode pad (e.g., 1402) is isolated by a non-conductive region, for example where the metal layer has been removed (or was not formed) between the signal inputs. A ground plane 1404 remains around the array, with thinner grounding strips between the signal inputs. The ground plane 1404 can be provided to establish a voltage bias between photocathode and anode 1400 to direct electrons from the photocathode toward the anode 1400. The upper, vacuum side of the anode 1400 is depicted in a top view in FIG. 15. The non-vacuum underside of the anode 1400 is depicted in a bottom view in FIG. 16 and in a side view in FIG. 17, showing the conductive pins (e.g., 1406) that pass through feedthroughs in the substrate to provide connections to the anode pads (e.g., 1402).

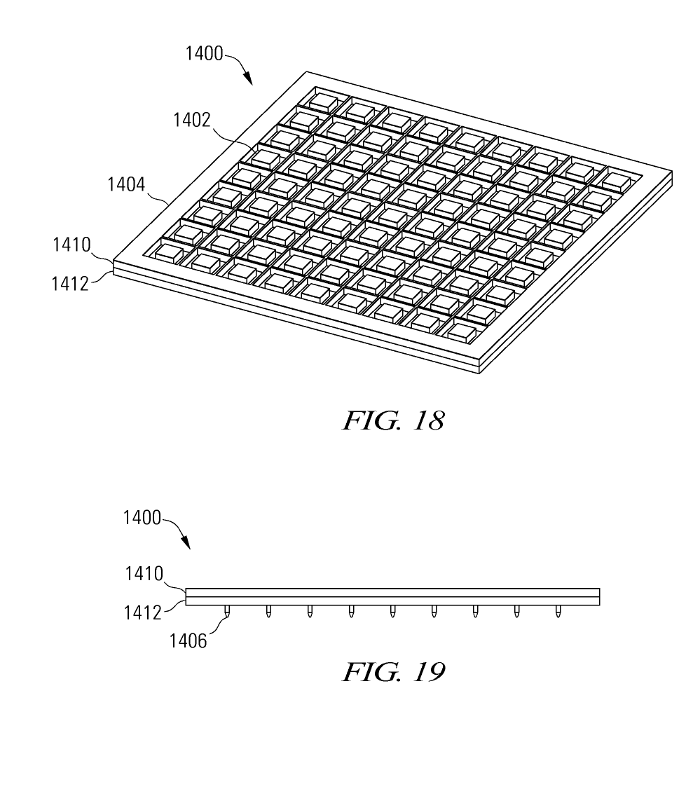

In some embodiments, each of the anode pads (e.g., 1402) is shielded by metal boundaries, for example using the conductive grid 1410 mounted above the substrate 1412 as depicted in perspective view in FIG. 18 and side view in FIG. 19.

Again, in some embodiments of the invention, a ground plane is located on the non-vacuum lower side of the substrate. In some other embodiments, the ground plane is provided on the vacuum upper side of the substrate surrounding the anode pads.

The conductive pins on the bottom side (exterior side, outside the vacuum) of the anode can be read in any suitable manner, such as, but not limited to, using a probe reader or a printed circuit board with contacts aligned with the conductive pins.

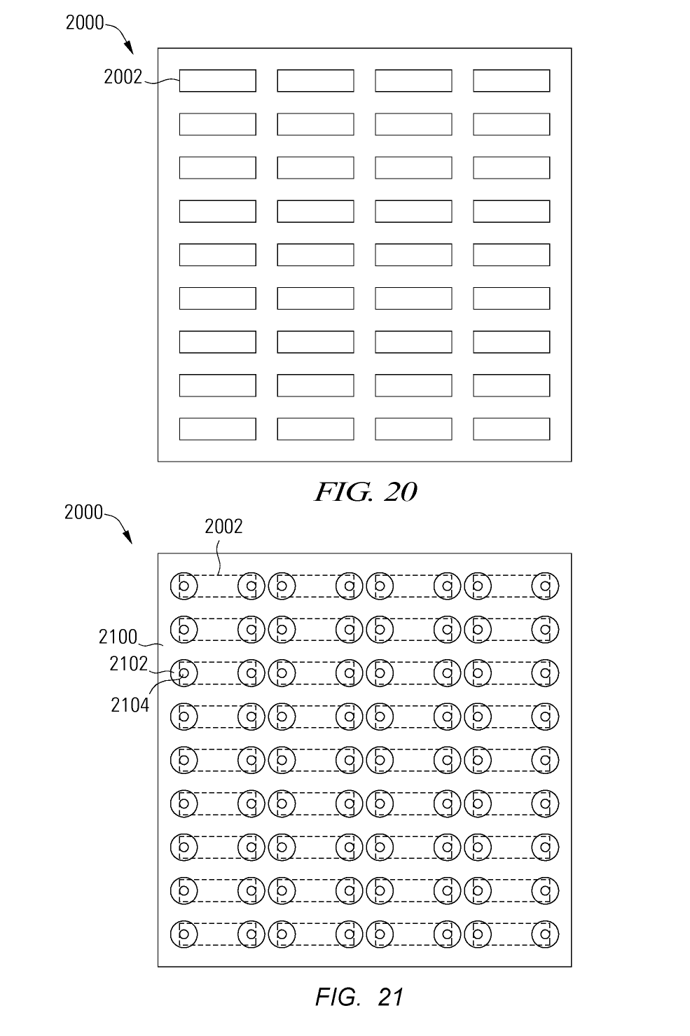

Turning to FIG. 20, the top view of an upper, vacuum side is depicted of an anode 2000 with a two-dimensional array of elongated anode pads (e.g., 2002) that are positioned within a vacuum in operation.

Turning to FIG. 21, a bottom view depicts the anode of FIG. 20, showing a conductive pin (e.g., 2104) connected through the substrate to each end of each of the elongated anode pads. The conductive pins can be formed in any suitable manner, such as, but not limited to, drilling holes through the substrate which are filled with an electrically conductive material in any suitable manner to provide conductive feedthroughs from the vacuum side to the non-vacuum side of the substrate. Such feedthroughs maintain a vacuum seal between the vacuum side to the non-vacuum side of the substrate. In some embodiments, pins (e.g., 2104) extend from the substrate on the non-vacuum side to provide electrical connections to the pads (e.g., 2002).

In some other embodiments, vias are formed between the vacuum-side and non-vacuum side to provide external connections to the elongated anode pads within the vacuum. Such vias can be, for example, holes drilled through the substrate and metal lined, metal-filled, or partially metal filled. For example, in some embodiments the walls of the holes are metal-lined and the hole is partially filled to maintain vacuum, forming an electrically conductive socket into which conductive pins can be inserted to read the signals. The conductive pins can be read in any suitable manner, such as, but not limited to, using a probe reader or a printed circuit board with contacts aligned with the conductive pins. The signals can be transmitted from the conductive pins across a printed circuit board to one of more of the four edges of the printed circuit board, where they can be connected to any suitable type of connectors. In the embodiment depicted in FIG. 21, substantially all of the non-vacuum underside of the substrate is covered with a ground plane 2100, except for cutouts or gaps (e.g., 2102) of any shape and size around the conductive pins (e.g., 2104).

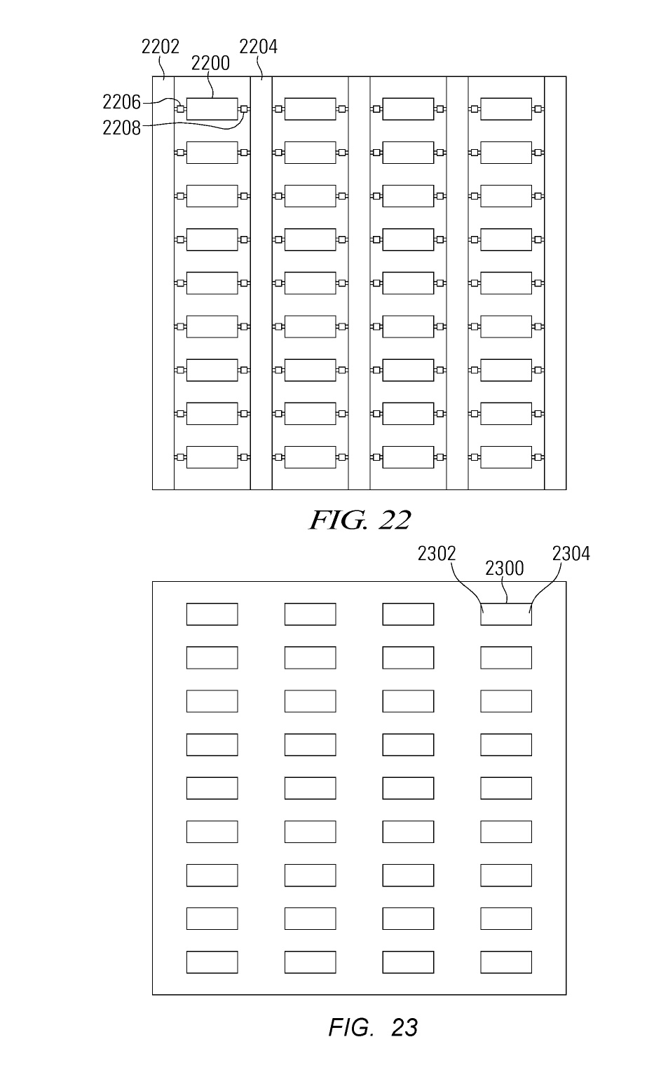

FIG. 22 depicts a top view of an embodiment of a multi-channel anode, in which a two-dimensional array of elongated pads (e.g., 2200) are located on the vacuum side. Ground strips (e.g., 2202, 2204) extend to the edges of the anode, passing through the vacuum housing walls, providing ground connections outside the housing. The elongated pads (e.g., 2200) are connected to the ground strips (e.g., 2202, 2204) at multiple points through resistors (e.g., 2206, 2208), such as, but not limited to, 50 Ohm resistors, allowing electrical currents to flow on the elongated pads (e.g., 2200) without reflections when struck by a photon or particle, etc.

FIG. 23 depicts a bottom view of the multi-channel anode of FIG. 22, showing a two-dimensional array of elongated pads on the non-vacuum side, inductively coupled to the two-dimensional array of elongated pads on the vacuum side shown in FIG. 22, allowing the signal to be retrieved outside the vacuum. When a current flows in one of the vacuum-side elongated pads (e.g., 2300), a proportional current is induced in a corresponding one of the non-vacuum side elongated pads (e.g., 2300). Signal connectors are electrically connected to each end (e.g., 2302, 2304) of the elongated pads (e.g., 2300) to sense the induced current. Additional ground plane material can be provided at any desired location on either or both the vacuum side or non-vacuum side of the anode around the elongated pads.

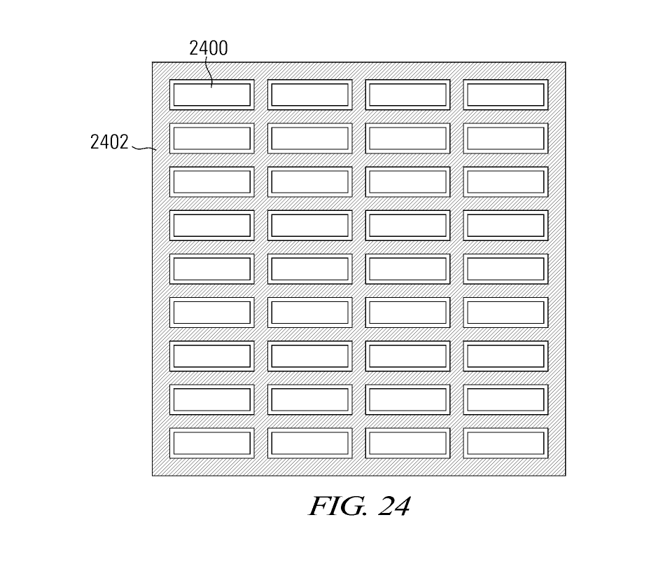

FIG. 24 depicts a bottom view of a multi-channel anode in which a two-dimensional array of elongated anode pads (e.g., 2400) is positioned on the non-vacuum side of a glass substrate, surrounded by a ground plane 2402 with insulating gaps between the elongated anode pads (e.g., 2400) and the ground plane 2402, and with signal connectors attached to the ends of the elongated anode pads (e.g., 2400).

While illustrative embodiments have been described in detail herein, it is to be understood that the concepts disclosed herein may be otherwise variously embodied and employed, and that the appended claims are intended to be construed to include such variations, except as limited by the prior art.

What is claimed is:

1. An anode, comprising:
a substrate;
a plurality of conductive regions on the substrate; and
a plurality of electrical conductors through the substrate, each connected to one of the plurality of conductive regions.

2. The anode of claim 1, wherein the anode comprises a two-dimensional anode array.

3. The anode of claim 1, wherein the anode comprises a two-dimensional multi-channel anode for large area photodetection.

4. The anode of claim 1, wherein the substrate and the plurality of electrical conductors through the substrate are operable to maintain a pressure differential between a first side of the substrate and a second side of the substrate.

5. The anode of claim 1, further comprising an electrically conductive ground plane adjacent the plurality of conductive regions.

6. The anode of claim 5, wherein the ground plane surrounds the plurality of conductive regions.

7. The anode of claim 5, wherein each of the plurality of conductive regions is separated by an insulating region.

8. The anode of claim 5, wherein the plurality of conductive regions are separated from the ground plane by an insulating region.

9. The anode of claim 1, wherein the substrate comprises glass.

10. The anode of claim 1, wherein the plurality of conductive regions comprises a two-dimensional array.

11. The anode of claim 1, wherein the plurality of conductive regions are square regions.

12. The anode of claim 1, wherein a shape and size of each of the plurality of conductive regions controls a desired detection bandwidth.

13. The anode of claim 1, wherein a shape and size of each of the plurality of conductive regions controls a desired detection time resolution.

14. The anode of claim 1, wherein a shape, size and distribution of the plurality of conductive regions is adapted based on a desired detection density.

15. The anode of claim 1, wherein a shape, size and distribution of the plurality of conductive regions is adapted based on a desired spatial resolution.

16. The anode of claim 1, wherein a shape, size and distribution of each of the plurality of conductive regions is adapted based on a desired detection density.

17. The anode of claim 1, wherein a shape, size and distribution of each of the plurality of conductive regions is adapted based on a desired spatial resolution.

18. The anode of claim 1, wherein multiplexing of signals from multiple ones of the plurality of conductive regions is employed to read out a signal from the multiple ones of the plurality of conductive regions in a particular detection area.

19. The anode of claim 1, wherein each of the plurality of conductive regions is shielded by metal boundaries in a conductive grid.

20. The anode of claim 1, wherein at least one of the plurality of conductive regions on the substrate comprises an elongated pad to which multiple ones of the plurality of electrical conductors through the substrate are connected.
